(19) United States
(12) Patent Application Publication
(10) Pub. No.: US 2021/0103201 A1
(43) Pub. Date: Apr. 8, 2021

(54) FLASH METERING FOR DUAL CAMERA DEVICES

(71) Applicant: QUALCOMM Incorporated, San Diego, CA (US)

(72) Inventors: Micha Galor Gluskin, San Diego, CA (US); Ying Noyes, San Diego, CA (US); Wenbin Wang, San Diego, CA (US)

(21) Appl. No.: 16/591,421

(22) Filed: Oct. 2, 2019

(51) Int. Cl. G03B 7/17; G03B 15/03; H04N 5/235

(52) U.S. Cl. CPC G03B 7/17; H04N 5/2354; H04N 5/2353; G03B 15/03

(57) ABSTRACT

Methods, systems, and devices for image processing are described. Devices with one or more sensors (e.g., devices with multiple cameras, such as a dual camera device) may perform flash metering techniques, using an auxiliary camera, during a flash duration used for main camera image capture. For example, a dual camera device may control camera flash parameters (e.g., flash duration, flash power), via auxiliary camera flash metering, during main camera image capture (e.g., during main camera exposure for image capture operations). A main camera may begin exposure and a flash may be initiated. During the flash, an auxiliary camera may be configured to perform flash metering operations (e.g., via images captured by the auxiliary camera). Based on flash metering information from the auxiliary camera, the dual camera device may configure or adjust camera settings (e.g., exposure settings, flash duration, flash end time, flash power) during main camera exposure and image capture.

### BACKGROUND

The following relates generally to image processing, and more specifically to improved flash metering for dual camera devices.

A device may include an optical instrument (e.g., a camera, an image sensor) for recording or capturing images, which may be stored locally, transmitted to another location, etc. For example, an image sensor may capture visual information using one or more photosensitive elements that may be tuned for sensitivity to a visible spectrum of electromagnetic radiation. Many electronic devices, such as smartphones, tablets, home security systems, automobiles, drones, aircrafts, etc. may use cameras to capture images and video. In some cases, a device may utilize flash techniques (e.g., light emission) for capturing images under low lighting conditions. For example, dark environments or other low lighting scenarios (e.g., such as nightscapes, dark rooms) may be illuminated by a device, via flash techniques.

### SUMMARY

The described techniques relate to improved methods, systems, devices, or apparatuses that support improved flash metering for dual camera devices. Generally, the described techniques provide for control of camera flash parameters, via auxiliary camera flash metering, during main camera image capture. For example, in multi-sensor devices (e.g., devices with multiple cameras, such as a dual camera device), it may be efficient to perform flash metering techniques, using an auxiliary camera of the multi-sensor device, during a flash duration used for main camera image capture.

A method of image processing at a device is described. The method may include configuring an auxiliary camera with a first frame rate and a main camera with a second frame rate, initiating capturing an image using the main camera, performing, using the auxiliary camera and while capturing the image using the main camera, light metering during a duration of a flash used by the main camera, determining, during the duration and while capturing the image using the main camera, a flash end time based on the light metering, deactivating, while capturing the image using the main camera, the flash used by the main camera based on the flash end time, and ending capturing the image by the main camera after deactivating the flash.

An apparatus for image processing at a device is described. The apparatus may include a processor, memory coupled with the processor, and instructions stored in the memory. The instructions may be executable by the processor to cause the apparatus to configure an auxiliary camera with a first frame rate and a main camera with a second frame rate, initiate capturing an image using the main camera, perform, using the auxiliary camera and while capturing the image using the main camera, light metering during a duration of a flash used by the main camera, determine, during the duration and while capturing the image using the main camera, a flash end time based on the light metering, deactivate, while capturing the image using the main camera, the flash used by the main camera based on the flash end time, and end capturing the image by the main camera after deactivating the flash.

Another apparatus for image processing at a device is described. The apparatus may include means for configuring an auxiliary camera with a first frame rate and a main camera with a second frame rate, initiating capturing an image using the main camera, performing, using the auxiliary camera and while capturing the image using the main camera, light metering during a duration of a flash used by the main camera, determining, during the duration and while capturing the image using the main camera, a flash end time based on the light metering, deactivating, while capturing the image using the main camera, the flash used by the main camera based on the flash end time, and ending capturing the image by the main camera after deactivating the flash.

A non-transitory computer-readable medium storing code for image processing at a device is described. The code may include instructions executable by a processor to configure an auxiliary camera with a first frame rate and a main camera with a second frame rate, initiate capturing an image using the main camera, perform, using the auxiliary camera and while capturing the image using the main camera, light metering during a duration of a flash used by the main camera, determine, during the duration and while capturing the image using the main camera, a flash end time based on the light metering, deactivate, while capturing the image using the main camera, the flash used by the main camera based on the flash end time, and end capturing the image by the main camera after deactivating the flash.

Some examples of the method, apparatuses, and non-transitory computer-readable medium described herein may further include operations, features, means, or instructions for configuring the auxiliary camera with a first exposure time and the main camera with a second exposure time longer than the first exposure time, where the ending of the capturing of the image occurs after an end of the second exposure time. Some examples of the method, apparatuses, and non-transitory computer-readable medium described herein may further include operations, features, means, or instructions for generating the image based on the capturing by the main camera, where a foreground of the image may be generated based on the capturing during the duration and a background of the image may be generated based on the capturing after the flash end time.

In some examples of the method, apparatuses, and non-transitory computer-readable medium described herein, the configuring may include operations, features, means, or instructions for configuring the auxiliary camera with the first frame rate and the main camera with the second frame rate that may be lower than the first frame rate. Some examples of the method, apparatuses, and non-transitory computer-readable medium described herein may further include operations, features, means, or instructions for determining, during the duration and while capturing the image using the main camera, an exposure end time based on the light metering, where the ending of the capturing of the image by the main camera may be based on the exposure end time.

Some examples of the method, apparatuses, and non-transitory computer-readable medium described herein may further include operations, features, means, or instructions for adjusting the duration of the flash used by the main camera, an exposure time of the main camera, the second frame rate of the main camera, or some combination thereof, based on the light metering.

Some examples of the method, apparatuses, and non-transitory computer-readable medium described herein may further include operations, features, means, or instructions for passing, from the auxiliary camera to a camera controller, light metering information based on the light metering, determining, by the camera controller, the adjustment based on the light metering information, and passing, from the camera controller to the main camera, an indication of the adjustment, where the duration of the flash used by the main camera, the exposure time of the main camera, the second frame rate of the main camera, or some combination thereof, may be adjusted by the main camera based on the indication of the adjustment. Some examples of the method, apparatuses, and non-transitory computer-readable medium described herein may further include operations, features, means, or instructions for adjusting the duration of the flash used by the main camera, the exposure time of the main camera, the second frame rate of the main camera, or some combination thereof occurs while capturing the image using the main camera.

In some examples of the method, apparatuses, and non-transitory computer-readable medium described herein, performing the light metering may include operations, features, means, or instructions for capturing one or more frames during the duration based on the first frame rate. In some examples of the method, apparatuses, and non-transitory computer-readable medium described herein, determining the flash end time further may include operations, features, means, or instructions for determining, based on the light metering, that an exposure level of a portion of at least one of the one or more captured frames exceeds a threshold, where the flash end time may be determined based on the determination that the exposure level exceeds the threshold.

### BRIEF DESCRIPTION OF THE DRAWINGS

FIG. 1A illustrates example images that support aspects of improved flash metering for dual camera devices in accordance with aspects of the present disclosure.

FIG. 1B illustrates example device architecture that supports improved flash metering for dual camera devices in accordance with aspects of the present disclosure.

FIGS. 2A and 2B illustrate example image capture timelines that support improved flash metering for dual camera devices in accordance with aspects of the present disclosure.

FIG. 3 illustrates an example of a flowchart that supports improved flash metering for dual camera devices in accordance with aspects of the present disclosure.

FIG. 4 illustrates an example of a flowchart that supports improved flash metering for dual camera devices in accordance with aspects of the present disclosure.

FIGS. 5A, 5B, and 5C illustrate example image capture timelines that support improved flash metering for dual camera devices in accordance with aspects of the present disclosure.

FIGS. 6A, 6B, and 6C illustrate example image capture timelines that support improved flash metering for dual camera devices in accordance with aspects of the present disclosure.

FIGS. 7 and 8 show block diagrams of devices that support improved flash metering for dual camera devices in accordance with aspects of the present disclosure.

FIG. 9 shows a diagram of a system including a device that supports improved flash metering for dual camera devices in accordance with aspects of the present disclosure.

FIGS. 10 and 11 show flowcharts illustrating methods that support improved flash metering for dual camera devices in accordance with aspects of the present disclosure.

### DETAILED DESCRIPTION

An image sensor (e.g., a camera) may capture visual information using one or more photosensitive elements that may be tuned for a visible spectrum of electromagnetic radiation. An imaging device (e.g., an image sensor, camera, video recorder, mobile device, computer) may use a processor (e.g., an image signal processor (ISP)) to restore images from captured raw data. A processor may implement computation methods utilizing pixel information to reconstruct or restore images captured by a sensor of the device. In some cases, a device (e.g., a dual camera device) may include one or more sensors (e.g., multiple image sensors or multiple cameras). For example, a device may employ an auxiliary camera (e.g., a sensor used for image capture operations or image processing operations such as flash metering, color correction, region segmentation) and a main camera (e.g., a sensor used for capturing of imaging information).

According to the techniques described herein, a dual camera device may perform flash metering techniques, using an auxiliary camera, during a flash duration used for main camera image capture. Generally, a camera controller (e.g., of a dual camera device) may utilize an auxiliary camera to adjust a flash duration, flash power levels, an exposure time of a main camera, a frame rate of a main camera, etc. during main camera exposure. For example, a dual camera device may control camera flash parameters (e.g., flash duration, flash power), via auxiliary camera flash metering, during main camera image capture (e.g., during main camera exposure for image capture operations).

A main camera may begin exposure and a flash may be initiated. During the flash, an auxiliary camera may be configured to perform flash metering operations (e.g., via images captured by the auxiliary camera). Based on information (e.g., flash metering information) received by the dual camera device via the auxiliary camera, the dual camera device may configure or adjust flash parameters (e.g., flash duration, flash end time, flash power) during the main camera exposure (e.g., during main camera image capture). In some examples, such techniques may be used for low light (e.g., nightscape, dark background environment) image capture. For example, main camera exposure may include the flash (e.g., with flash parameters configured or adjusted based on flash metering operations performed by the auxiliary camera) and may continue after the flash duration (e.g., after the flash is turned off). As such, the dual camera device may more effectively image foreground objects (e.g., based on main camera exposure overlapping with the flash duration) and background objects (e.g., based on main camera exposure after the flash end), as described in more detail herein.

Aspects of the disclosure are initially described in the context of image generation examples and example dual camera device architecture. Example image capture timelines and flowcharts for implementing the described techniques are then discussed. Aspects of the disclosure are further illustrated by and described with reference to apparatus diagrams, system diagrams, and flowcharts that relate to improved flash metering for dual camera devices

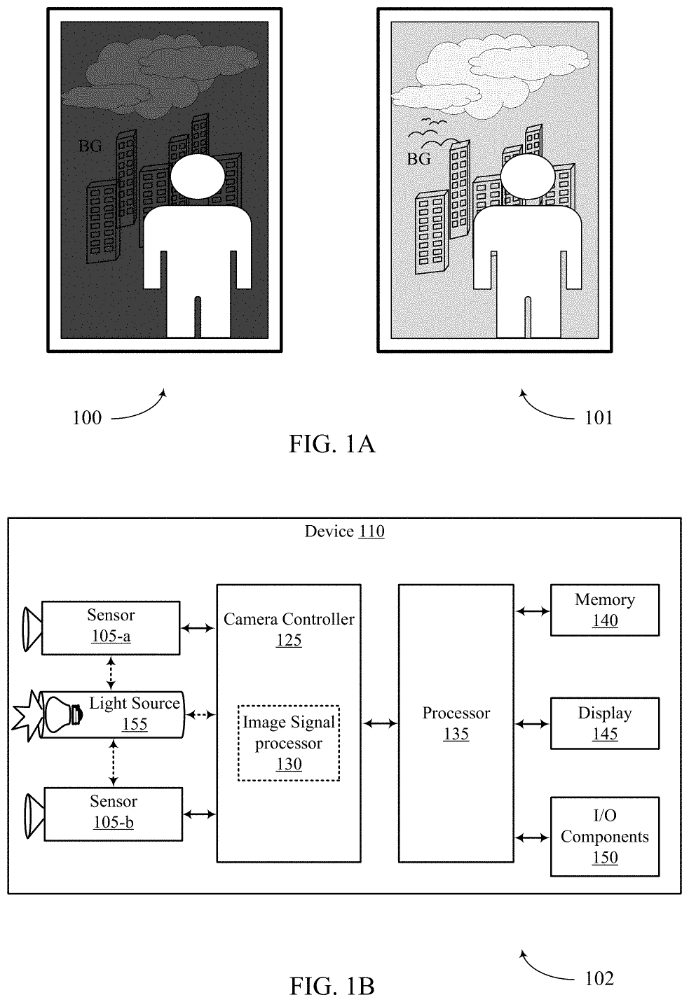

FIG. 1A illustrates an example image 100 and an example image 101 that may demonstrate aspects of improved flash metering for dual camera devices in accordance with aspects of the present disclosure. As discussed herein, device may capture visual information using one or more photosensitive elements that may be tuned for sensitivity to a visible spectrum of electromagnetic radiation. However, in some cases (e.g., in low lighting conditions, dark environments, nightscapes), natural illumination of the scene or image being captured may provide inadequate light in the visible spectrum of electromagnetic radiation. In some cases, a device may utilize a flash to help illuminate a scene or object being captured, such that a device may capture an image (e.g., visual information) more effectively. A flash may refer to a device, or component of a device (e.g., a light source), used to produce a flash of artificial light (e.g., for 1/1000 to 1/200 of a second) at some color temperature (e.g., ˜5500K) to help illuminate a scene naturally under low lighting conditions (e.g., such as nightscapes, indoor scenes). In some cases, a flash may refer to the flash of light itself or the electronic flash unit discharging the flash of light.

Generally, a device (e.g., a dual camera device) may utilize a flash to illuminate a dark scene, illuminate an object, change the quality or appearance of scene lighting, capture quickly moving objects, etc. In some examples, a device may utilize flash metering techniques for camera configuration (e.g., for configuration of camera exposure settings, for configuration of flash parameters, such as flash duration, flash power). For example, flash metering techniques may include measurement of lighting information (e.g., exposure value (EV) measurements), processing of such lighting information, and configuration of camera settings and/or flash settings based on processed lighting information. When measuring light level for exposure, a device may use EV. EV may represent the multiplication of shutter speed (e.g., integration time), sensor gain, and aperture area (e.g., ShutterSpeed×SensorGain×AperatureArea). In some cases, EV may be specified in logarithmic units, linear units, etc. High EV values may represent low light levels (e.g., low lighting conditions), as lower light levels may be associated with longer exposure durations and higher gain levels. In some examples, center weighted metering techniques may compare a weighted average of the pixels value to current exposure parameters and a predefined target average (e.g., EV=(Average/Target)×ShutterSpeed×SensorGain×AperatureArea).

Some flash metering techniques may measure EV with flash off (EV_{off}), measure EV with flash on (EVₒₙ) (e.g., during a pre-flash stage), subtract EVₒₙ−EV_{off} (e.g., to determine flash contribution), and determine exposure settings and flash duration/power settings for main image capture. Generally, a device may perform flash metering with flash off (e.g., measure EV_{off}) and/or perform pre-flash metering (e.g., EVₒₙ measurements, which may be repeated at different exposures, flash durations, flash powers, etc.) to determine camera settings. A device may utilize information from such measurements to determine camera settings such as exposure settings, integration time settings, aperture settings, flash duration settings, flash power settings, etc. (e.g., where flash off measurements and/or pre-flash measurements may be used in calculation of such camera settings). The device may then turn on a flash and capture an image according to the configured camera settings.

When taking a snapshot (e.g., capturing an image) with flash, it may be difficult to predict and configure exposure and flash power, as objects reflectance may be unknown, near objects may be relatively more illuminated by the flash (e.g., which may cause near foreground (FG) objects to be clipped, while farther background (BG) objects brightness may be illuminated less or not at all), etc. As such, flash metering techniques may use pre-flashes to perform exposure metering with the flash on. For example, a Xenon flash may be implemented (e.g., achieved by a series of short flashed), a light emitting diode (LED) flash may be implemented (e.g., by turning on the flash at low power), etc. In such examples, a main camera may capture several frames to determine the exposure and flash power for the actual snapshot (e.g., the main camera may capture several frames via light metering techniques, to determine exposure and flash power for the image capture). In some examples, a device may use digital single-lens reflex (DSLR) flash techniques, where a special sensor (e.g., an auxiliary camera) may be dedicated for flash metering (e.g., off the film (OTF) or through-the-lens (TTL) techniques may electronically cut down the flash burst in the middle of an exposure duration to avoid over-exposure).

In some aspects, conventional flash techniques may be improved upon. For example, in some cases, conventional flash techniques may overexpose FG object(s) and/or under expose BG object(s) (e.g., such as background landscape) resulting in images similar to that of example image 100. Example image 100 may illustrate situations where some BG may be too far away to be illuminated by the flash, which may ultimately result in undesirable exposure of such BG, over exposure of FG objects, etc. Further, conventional flash metering techniques utilizing pre-flashes may be associated with additional power consumption, increased latency (e.g., pre-flash techniques may increase the lag or delay from the shutter press to the image capture), etc. In some cases, pre-flash metering techniques may also be more intrusive to the subject or scene being imaged (e.g., pre-flashes may bother or disturb subjects being imaged, such as humans, animals).

According to the techniques described herein, a dual camera device may utilize auxiliary sensor (e.g., auxiliary camera) flash metering during main sensor (e.g., main camera) exposure. Further, the main sensor exposure may extend beyond a flash duration end time (e.g., which may be configured based on auxiliary sensor flash metering techniques) for improved imaging of FG objects and BG objects. During a flash, an auxiliary sensor may be configured to perform flash metering operations (e.g., via images captured by the auxiliary sensor). Based on information (e.g., flash metering information) received by the dual camera device via the auxiliary sensor, the dual camera device may configure or adjust flash parameters (e.g., flash duration, flash end time, flash power), exposure settings, color settings, region segmentation settings, etc. during the main sensor exposure (e.g., during main camera image capture). In some examples, such techniques may be used for capturing images in low lighting conditions (e.g., nightscapes, dark background environments).

For example, example image 101 may be captured using aspects of the techniques described herein. For capturing example image 101, a dual camera device may configure an exposure duration for a main camera that includes a flash (e.g., with flash parameters configured or adjusted based on flash metering operations performed by the auxiliary camera) and continues after the flash duration (e.g., the main camera exposure may be configured to continue after the flash is turned off). As such, the dual camera device may more effectively image FG objects (e.g., based on main camera exposure overlapping with the flash duration) and BG objects (e.g., based on main camera exposure after the flash end), as described in more detail herein. Further such techniques may reduce device power consumption (e.g., via reduction or elimination of pre-flash operations), reduce imaging latency (e.g., as camera settings may be configured during main camera exposure), etc.

Techniques described with reference to aspects of example image 100 and example image 101 are done so for exemplary purposes, and are not intended to be limiting in terms of the applicability of the described techniques. That is, the techniques described may be implemented in, or applicable to, other imaging examples (e.g., other examples of image sensor or camera based applications, such as security systems, drone imaging), without departing from the scope of the present disclosure. For example, the techniques described may generally provide for improved flash metering techniques for dual camera devices (e.g., via usage of an auxiliary camera during main camera exposure, such that flash parameters, exposure settings, etc. may be configured or adjusted during main camera exposure).

FIG. 1B illustrates an example of a device architecture 102 that supports improved flash metering for dual camera devices in accordance with aspects of the present disclosure. For example device architecture 102 may illustrate an example architecture of a device 110 (e.g., a dual camera device). As discussed, a device 110 may include sensor 105-a (e.g., a main sensor, main camera) and sensor 105-b (e.g., an auxiliary sensor, auxiliary camera). Sensor 105-a and sensor 105-b may be in electronic communication with an camera controller 125, an image signal processor 130 (e.g., some image signal processor and/or image signal processing software), and a processor 135 (e.g., a general processor of the device 110). In some cases, sensor 105-a and sensor 105-b may be in electronic communication with an camera controller 125, and the camera controller 125 may be in electronic communication with the image signal processor 130 and/or the processor 135. In some examples, the camera controller 125, the image signal processor 130, and/or the processor 135 may be implemented on a single substrate or system on chip (SoC), or may be separately located.

As used herein, a device 110 may refer to any device with a camera, image sensor, light sensor, etc. In some cases, device 110 may refer to a camera, a mobile device, a wireless device, a remote device, a handheld device, a subscriber device, a personal electronic device such as a cellular phone, a personal digital assistant (PDA), a tablet computer, a laptop computer, a personal computer, or some other suitable terminology. Further examples of devices 110 that may implement one or more aspects of improved flash metering for dual camera devices may include camcorders, webcams, computer monitors, drones, cockpit controls and/or displays, camera view displays (such as the display of a rear-view camera in a vehicle), etc. The term “device” is not limited to one or a specific number of physical objects (such as one smartphone). As used herein, a device 110 may be any electronic device with multiple parts that may implement at least some portions of this disclosure. In some examples, a device 110 may be a video security system including one or more hubs and two or more separate cameras. As another example, a device 110 may be a smartphone including two cameras such as sensor 105-a and sensor 105-b. While the described techniques and examples use the term “device” to describe various aspects of this disclosure, the term “device” is not limited to a specific sensor or hardware configuration, type, or number of objects.

Any of such devices may include at least one camera or light sensor (e.g., sensor 105) that outputs a signal, or information bits, indicative of light (e.g., reflective light characteristics of scene (e.g., which may include FG and BG objects or landscapes), light emitted from scene, an amount or intensity of light associated with scene, red green blue (RGB) values associated with scene). For example, a sensor 105 may include a lens (e.g., to capture or focus incoming light), a color filter array (CFA) (e.g., to filter the incoming light according to different individual filter elements of the CFA), a pixel sensor array (e.g., to detect or measure the filtered light), and/or other hardware or components for capturing such light or image information. The sensor 105 may then signal or pass information collected to other components of the device 110 (e.g., a camera controller 125, an image signal processor 130, a processor 135). In some aspects, one of the cameras (such as sensor 105-a) may be a primary camera or main camera, and the other camera (such as sensor 105-b) may be an auxiliary camera. In some examples, the sensor 105-b may have a different focal length, capture rate, resolution, color palette (such as color versus black and white), and/or field of view or capture than the sensor 105-a. While described herein with respect to a device including two sensors 105 (e.g., two cameras), aspects of the present disclosure are applicable to any number of sensors, cameras, camera configurations, etc., and are therefore not limited to two cameras.

In some cases, a sensor 105 may refer to a complementary metal oxide semiconductor (CMOS) image sensor, a charge-coupled device (CCD), etc. used in digital imaging applications to capture images (e.g., scenes, target objects within some scene). In some examples, a sensor 105 may include an array of sensors (e.g., a pixel sensor array). Each sensor in the pixel sensor array may include at least one photosensitive element for outputting a signal having a magnitude proportional to the intensity of incident light or radiation contacting the photosensitive element. When exposed to incident light reflected or emitted from a scene (e.g., or target FG object within some scene), each sensor in the pixel sensor array may output a signal having a magnitude corresponding to an intensity of light at one point in the scene (e.g., at an image capture time). The signals output from each photosensitive element may be processed (e.g., by the camera controller 125, image signal processor 130, and/or processor 135) to form an image representing the captured scene. In general, a pixel brightness measurement or a pixel value from a sensor 105 (e.g., from pixel sensor array) may correspond to a pixel intensity value, RGB values of a pixel, infrared values of a pixel, or any other parameter associated with light (e.g., or the image being captured, the picture being taken). In some examples, a pixel sensor array may include one or more photosensitive elements for measuring such information. In some examples, the photosensitive elements may have a sensitivity to a spectrum of electromagnetic radiation (e.g., including the visible spectrum of electromagnetic radiation, infrared spectrum of electromagnetic radiation). For example, the at least one photosensitive element may be tuned for sensitivity to a visible spectrum of electromagnetic radiation (e.g., by way of depth of a photodiode depletion region associated with the photosensitive element).

Device 110 may be any suitable device capable of capturing images or video including, for example, wired and wireless communication devices (such as camera phones, smartphones, tablets, security systems, dash cameras, laptop computers, desktop computers, automobiles, drones, aircraft, and so on), digital cameras (including still cameras, video cameras, and so on), or any other suitable device. The example device 110 is shown in to include a first sensor 105-a, a second sensor 105-b, a processor 135, a memory 140, a camera controller 125 (e.g., which may include an image signal processor 130, or in some cases the processor 135 and/or camera controller 125 may perform image signal processing operations), a display 145, and a number of input/output (I/O) components 150. The device 110 may include additional features or components not shown. For example, a wireless interface, which may include a number of transceivers and a baseband processor, may be included for a wireless communication device. In some cases, device 110 may include additional sensors or cameras other than senor 105-a and sensor 105-b. The disclosure should not be limited to any specific examples or illustrations, including example device 110.

As discussed herein, a sensor 105 may generally refer to a camera, an image sensor, a light sensor, other sensors, or the like. For example, a sensor 105 may include a lens, a color filter array, a pixel sensor array, and/or other hardware which may collect (e.g., focus), filter, and detect lighting information. The lighting information may be passed to a camera controller 125 (e.g., for processing and reconstruction of the raw image data by an image signal processor 130). The image signal processor 130 (e.g., one or more driver circuits for performing image processing operations) may then process the information collected by the sensor 105 (e.g., to reconstruct or restore the captured image of scene). In some examples, the processed image information (e.g., determined or output from the camera controller 125, image signal processor 130, and/or processor 135) may then be passed to a display 145 of the device. In other examples, the processed image information may be stored by the device, passed to another device, etc. The camera controller 125 may include one or more driver circuits for controlling sensor 105-a and/or sensor 105-b (e.g., driver circuits for configuring an auxiliary camera, such as sensor 105-b, to perform flash metering techniques, for configuring flash parameters for light source 155, for configuring a main camera, such as sensor 105-a, with exposure settings).

The sensor 105-a and sensor 105-b may be capable of capturing individual image frames (such as still images) and/or capturing video (such as a succession of captured image frames). In some cases, the sensor 105-a and sensor 105-b also may themselves include one or more image sensors or pixel arrays (not shown for simplicity) and shutters for capturing an image frame and providing the captured image frame to the camera controller 125. The memory 140 may be a non-transient or non-transitory computer readable medium storing computer executable instructions to perform all or a portion of one or more operations described in this disclosure. In some cases, the device 110 may also include a power supply, which may be coupled to or integrated into the device 110.

The processor 135 may be one or more suitable processors capable of executing scripts or instructions of one or more software programs (such as instructions) stored within memory 140. In some aspects, the processor 135 may be one or more general purpose processors that execute instructions to cause the device 110 to perform any number of functions or operations. In additional or alternative aspects, the processor 135 may include integrated circuits or other hardware to perform functions or operations without the use of software. While shown to be coupled to each other via the processor 135 in the example of FIG. 1, the processor 135, memory 140, camera controller 125, the display 145, and I/O components 150 may be coupled to one another in various arrangements. For example, the processor 135, memory 140, camera controller 125, the display 145, and/or I/O components 150 may be coupled to each other via one or more local buses (not shown for simplicity).

The display 145 may be any suitable display or screen allowing for user interaction and/or allowing for presentation of information (such as captured images and video) for viewing by a user. In some aspects, the display 145 may be a touch-sensitive display. The I/O components 150 may be or may include any suitable mechanism, interface, or device to receive input (such as commands) from the user and to provide output to the user. For example, the I/O components 150 may include (but are not limited to) a graphical user interface, keyboard, mouse, microphone and speakers, and so on.

The camera controller 125 may include an image signal processor 130, which may be one or more image signal processors to process captured image frames or video provided by the sensor 105-a and/or the sensor 105-b. In some example implementations, the camera controller 125 (such as image signal processor 130) may control operation of the sensor 105-a and the sensor 105-b. In some aspects, the image signal processor 130 may execute instructions from a memory (such as instructions from memory 140 or instructions stored in a separate memory coupled to the image signal processor 130) to control operation of the sensor 105-a and the sensor 105-b. In other aspects, the camera controller 125 may include specific hardware to control operation of the sensor 105-a and the sensor 105-b. The camera controller 125 and/or image signal processor 130 may alternatively or additionally include a combination of specific hardware and the ability to execute software instructions.

As discussed herein, device may capture visual information using one or more photosensitive elements that may be tuned for sensitivity to a visible spectrum of electromagnetic radiation. However, in some cases, a device may capture an image (e.g., visual information) in dark environments or scenarios where the natural illumination of the scene or image being captured provides for inadequate light in the visible spectrum of electromagnetic radiation being captured. In some cases, a device may utilize a flash (e.g., via light source 155) to help illuminate a scene or object being captured.

Techniques described with reference to aspects of device 110 are done so for exemplary purposes, and are not intended to be limiting in terms of the applicability of the described techniques. That is, the techniques described may be implemented in, or applicable to, other devices, without departing from the scope of the present disclosure. For example, the techniques described may generally provide for improved flash metering techniques for dual camera devices (e.g., via usage of an auxiliary sensor 105-b during main sensor 105-a exposure or main sensor 105-a image capture, such that flash parameters, exposure settings, etc. may be configured or adjusted during main sensor 105-a exposure). Utilization of such techniques may provide for reduced latency associated with tuning or calibration of appropriate flash settings (e.g., light source 155 settings) and/or sensor 105 settings for image capture operations. Further, in some cases, utilization of such techniques may provide for improved image capture (e.g., more accurate image generation) based on real-time adjustments (e.g., configuration) of sensor 105 settings and/or light source 155 settings.

In some examples, sensor 105-a (e.g., the main camera) may be configured with a slow frame rate, and the sensor 105-b (e.g., the auxiliary camera) may be configured with a high frame rate. In some cases, the main camera may not be configured with a constant frame rates. Based on sensor 105-b metering, device 110 may determine when to turn off the flash (e.g., when to turn off light source 155) and when to send a command (e.g., via camera controller 125) to sensor 105-a to stop exposure. In some cases, instead of keeping exposure at a constant value for the sensor 105-a, the exposure settings may be adjusted (e.g., to reduce exposure of the sensor 105-a if desirable). As such, sensor 105-a exposure may be modified while a frame is being exposed (e.g., a main camera may be configured with a long integration time that may be adjusted during the exposure, rather than being limited to adjusting exposure for future frames).

In some examples, a device 110 may perform aspects of the techniques described herein using a single camera (e.g., using a single sensor 105). For example, a device 110 may solely include a main camera (e.g., sensor 105-a). The main camera may be configured to give readouts during integration time. For example, the main camera may readout at a smaller resolution, and may readout several times during integration time (e.g., instead of using auxiliary camera metering). The main camera may be configured without reset such that intermediate readouts may be fast and small in resolution. In some cases, the device 110 may accumulate or combine multiple readouts to effectively result long exposure. That is, a main camera may provide auxiliary readouts by producing incremental fast readouts at low resolution without resetting, and the main camera may then compose images (e.g., incremental readouts) to generate final long exposure. In some cases, such frames may be used for image processing. For example, a device 110 may analyze some second frame versus the combined frame and may apply different tone mapping and color compensation to BG and FG to produce a more natural looking image. Generally, a main camera may be configured such that short readouts (e.g., without camera reset) may be used for metering (e.g., for configuration of camera settings, flash settings), and the readouts may then be combined for long exposure to generate the image (e.g., based on the camera configuration/adjustments).

In some cases, aspects of the described techniques may be implemented with two cameras (e.g., sensor 105-a and sensor 105-b) having a same frame rate. In such cases, an auxiliary camera (e.g., sensor 105-b) may be configured with a shorter integration time (e.g., and may rest and readout while the flash is on). The readouts of the two cameras may be in separate phases (e.g., not concurrent). In some cases, such may have additional value as this readout may share the same low voltage differential signaling (LVDS)/mobile industry processor interface (MIPI) channels.

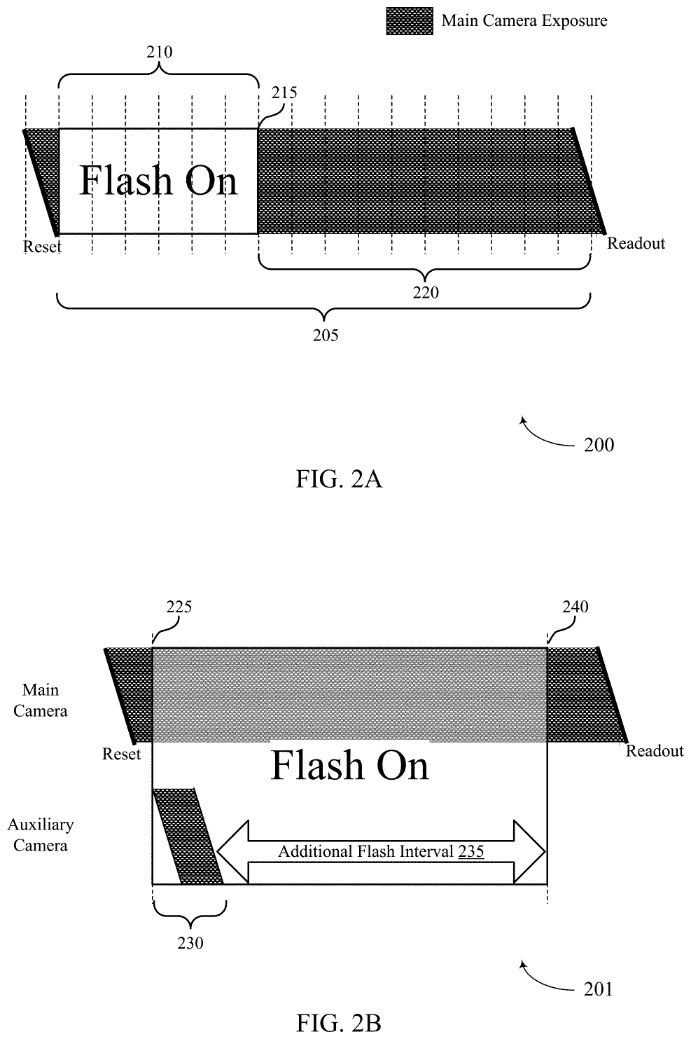

FIG. 2A illustrates an example of an image capture timeline 200 that supports improved flash metering for dual camera devices in accordance with aspects of the present disclosure. In some examples, image capture timeline 200 may illustrate aspects of techniques performed by a device (e.g., such as a device 110 as described with reference to FIG. 1B). For example, image capture timeline 200 may illustrate a main camera exposure duration 205, a flash duration 210 (e.g., and a corresponding flash end time 215), and a duration 220 (e.g., a duration 220 where exposure of the main camera continues beyond a flash end time 215). In some cases, the main camera exposure duration 205, the flash duration 210 (e.g., and flash end time 215), and the duration 220 may generally be referred to as camera settings (e.g., which may be configured according to techniques described herein).

In some cases, image capture timeline 200 may illustrate aspects of slow sync flash techniques (e.g., long exposure and short flash techniques). In some cases, such may be implemented in low lighting conditions, where the background may be too distant to be illuminated by the flash. A sensor (e.g., a main camera) may be configured with a long integration time (e.g., 100-200 ms), and the flash may be turned on as soon as the sensor reset has passed the last sensor line (e.g., the flash duration 210 may begin as soon as the sensor reset as passed the last sensor line). As discussed herein, the main camera exposure duration 205 may include a flash duration 210 and a duration 220. Duration 220 may refer to exposure time that extends beyond the flash. Aspects of such techniques may provide for improved image capture. For example, a FG object may be illuminated during a flash duration 210, and such illumination may be captured during main camera exposure (e.g., as during the flash, the FG may be illuminated more than BG, and thus may contribute more to the main camera exposure). As the exposure of the main camera continues during duration 220, the FG object may not be illuminated (e.g., when flash is off), and may contribute relatively less to the overall imaging of the FG object over the full integration time. Further, during the exposure of the main camera continues during duration 220, BG may contribute relatively more to the overall imaging. As such, a device may integrate pixel exposure over the main camera exposure duration 205 for improved imaging of both FG object(s) and BG object(s) (e.g., as described herein, for example, with reference to example image 101).

In some examples, devices may implement aspects of image capture timeline 200 without using pre-flash techniques. As described herein, a device may utilize an auxiliary camera for flash metering during the flash duration 210. The flash metering techniques performed via the auxiliary camera may be used by a device to turn off the main flash to prevent over exposure (e.g., of FG object(s)). That is, flash metering techniques performed via the auxiliary camera may be used by the device to configure flash settings, such as flash power, flash duration 210, flash end time 215, etc. The exposure of the main camera (e.g., main camera exposure duration 205) may continue through duration 220 to properly expose BG (e.g., to expose BG object(s) too distant for flash illumination). In some examples, the main camera may be configured with long exposure (e.g., with a main camera exposure duration 205), and the auxiliary camera may be configured to perform light metering techniques during the flash duration 210 (e.g., at 480 frames per second (FPS)). Just before the FG object(s) (e.g., the intended subject of the imaging) get over-exposed, the device may power down the flash (e.g., via software) based on the auxiliary camera flash metering.

That is, auxiliary camera flash metering may be used by the device (e.g., during the flash duration 210) to configure a flash end time 215 during main camera exposure duration 205. For example, the auxiliary camera may capture images during the flash, and the device may use such captured information to determine camera settings, flash settings, color settings, region segmentation with and without flash, etc. during main camera exposure. For example, the auxiliary camera may perform metering using images captured with a high frame rate while the flash it on. In some cases, flash metering techniques employed by a device may use both information captured by the auxiliary camera and the main camera (e.g., camera settings, flash settings, color settings, etc. may be configured based on information capture by both the auxiliary camera and the main camera during the flash duration 210). For example, a device auto exposure function may use both results of main camera metering and auxiliary camera metering. Generally, the light source 155 may be separate from the sensor and lens of the cameras (e.g., sensors 105-a and sensor 105-b), and resulting flash or light from light source 155 may be collected by both cameras.

FIG. 2B illustrates an example of an image capture timeline 201 that supports improved flash metering for dual camera devices in accordance with aspects of the present disclosure. In some examples, image capture timeline 201 may illustrate aspects of techniques performed by a device (e.g., such as a device 110 as described with reference to FIG. 1B). Specifically, image capture timeline 201 may illustrate dual camera flash metering techniques based on a single (e.g., or a few) captured auxiliary camera frames (e.g., such that the auxiliary camera may be configured with a lower FPS).

For example, image capture timeline 201 may illustrate flash being turned on (e.g., at 225) before auxiliary camera reset. The auxiliary camera may perform flash metering during a duration 230. A device may configure a hardware interrupt for any additional flash time (e.g., during additional flash interval 235). The flash may then be turned off (e.g., at 240). In some cases (e.g., if additional flash time is configured during additional flash interval 235), hardware interrupt may trigger software driver to turn off flash, or flash turn off may be directly support by flash controller. For example, the flash may be configurable (e.g., flash end time 240 may be configurable) based on auxiliary camera flash metering during duration 230, such that the flash may (e.g., depending on flash metering information) be extended into additional flash interval 235 as desirable.

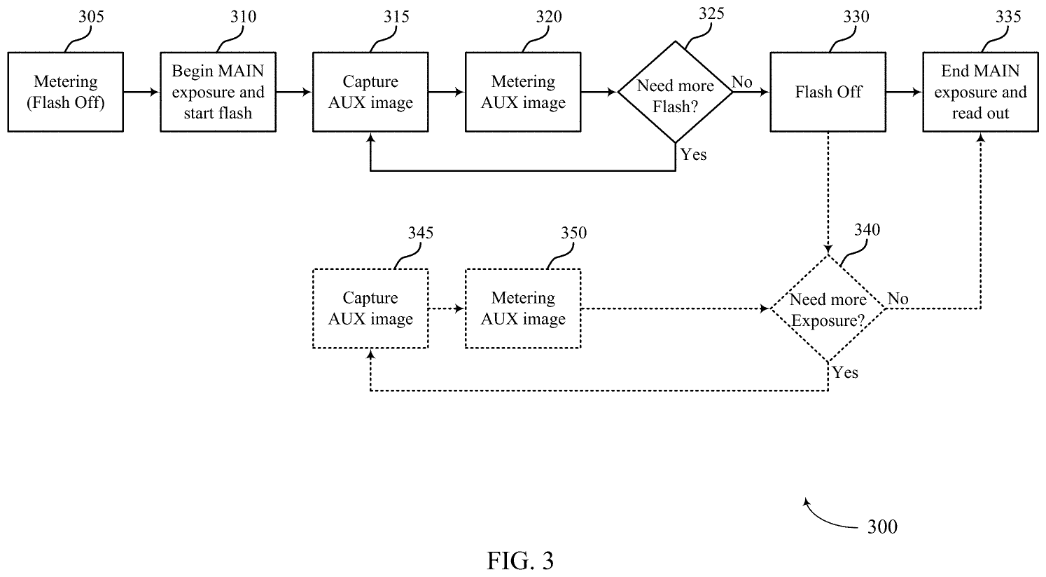

FIG. 3 illustrates an example of a flowchart 300 that supports improved flash metering for dual camera devices in accordance with aspects of the present disclosure. In some examples, flowchart 300 may illustrate aspects of techniques performed by a device (e.g., such as a device 110 as described with reference to FIG. 1B).

At 305, a device may begin metering (e.g., with flash off). At 310, a device may begin exposure of the main (‘MAIN’) camera, and may start (e.g., initiate) a flash. At 315, the device may capture auxiliary (‘AUX’) information (e.g., AUX frames or AUX images) using the auxiliary camera. At 320, the device may perform metering techniques (e.g., using the AUX information captured at 315). For example, the device may analyze light metering information captured at 315 to determine camera settings, flash settings, etc. At 325, the device may determine whether additional flash is needed (e.g., the device may determine whether to continue the flash duration and auxiliary camera flash metering, or whether to end the flash). In some cases, flash metering information captured by the auxiliary camera (e.g., EV measurements) may be used to determine whether or not to continue the flash. If the device determines more flash time (e.g., and thus more auxiliary camera image capture and image metering) is desirable, the device may repeat 315 and 320. If the device determines more flash time is not necessary, the device may proceed to end the flash at 330.

After the flash is ended at 330, the device may end main camera exposure after some additional duration (e.g., for BG exposure) as described herein, and may read out pixel values determined over the main camera exposure duration. In some cases, after the flash is ended at 330, the device may determine whether additional exposure is desired at 340. If the device determines additional exposure time is desired (e.g., based on auxiliary camera metering), the device may capture additional information using the auxiliary camera at 345, meter auxiliary images at 350, and then reevaluate whether yet additional exposure is desirable. Once the device determines that additional exposure is not necessary, the device may end main camera exposure and read out pixel values determined over the main camera exposure duration.

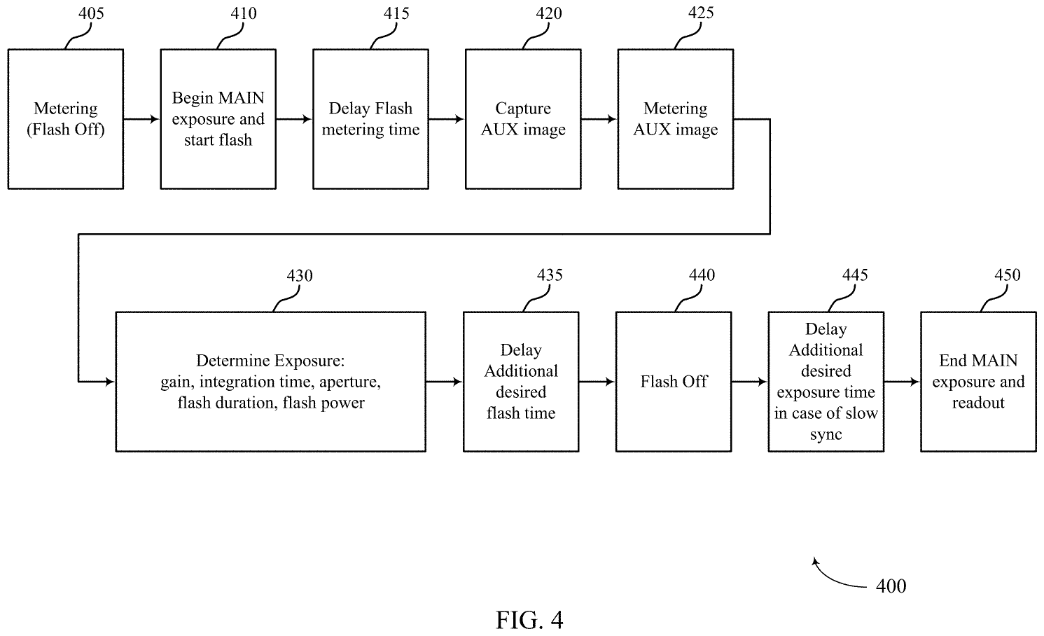

FIG. 4 illustrates an example of a flowchart 400 that supports improved flash metering for dual camera devices in accordance with aspects of the present disclosure. In some examples, flowchart 400 may illustrate aspects of techniques performed by a device (e.g., such as a device 110 as described with reference to FIG. 1B).

At 405, a device may a device may begin metering (e.g., with flash off). At 410, a device may begin exposure of the main (‘MAIN’) camera, and may start (e.g., initiate) a flash. At 415, the device may delay flash metering time (e.g., the device may configure the main camera to begin exposure, and the flash metering may be delayed until some time mid-exposure). At 420, the device may capture auxiliary (‘AUX’) information (e.g., AUX frames or AUX images) using the auxiliary camera. At 425, the device may perform metering techniques (e.g., using the AUX information captured at 420). The device may analyze light metering information captured at 420 to determine camera settings, flash settings, etc. For example, at 430, the device may determine exposure settings (e.g., gain, integration time, aperture, flash duration, flash power) based on metering one or more AUX images at 425. At 435, the device may determine to delay additional flash time (e.g., based on metering one or more AUX images, based on configuration of the exposure settings). At 440, the device may turn off the flash (e.g., end the flash duration). At 445, the device may, in some cases, delay additional desired exposure time (e.g., in case of slow sync). At 450, the device may end main camera exposure and read out pixel values determined over the main camera exposure duration.

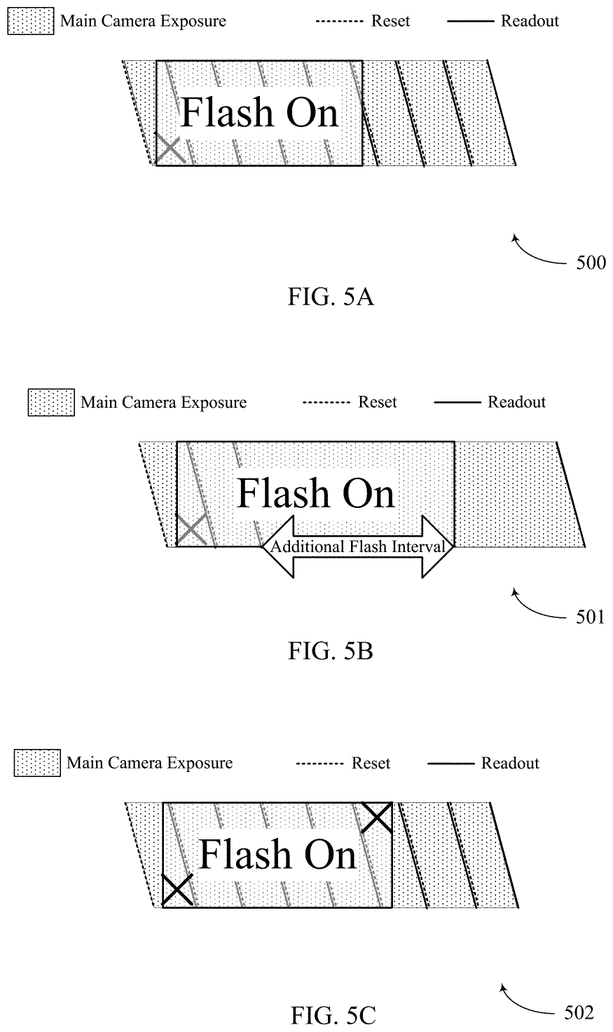

FIG. 5A illustrates an example of an image capture timeline 500 that supports improved flash metering for dual camera devices in accordance with aspects of the present disclosure. In some examples, image capture timeline 500 may illustrate aspects of techniques performed by a device (e.g., such as a device 110 as described with reference to FIG. 1B). Specifically, image capture timeline 500 may illustrate multi-frame flash metering techniques based on one or more captured auxiliary camera frames. In some cases, aspects of image capture timeline 500 may be implemented by a single camera (e.g., auxiliary readouts may be employed by a camera performing main image capture). As such, in some cases, techniques described in the example of FIG. 5A may be performed by a single camera device, by a single camera of a dual camera device, etc.

Example image capture timeline 500 may illustrate implementation of rolling shutter compensation (e.g., a frame marked by “X” may be associated with a rolling shutter exposure issue). For example, due to rolling shutter (e.g., and a flash starting in the middle of a readout), an initial readout may show more flash contribution in bottom lines (e.g., in bottom lines of the readout, after the flash has started). As such, a device may not perform metering techniques using a first frame (e.g., a frame where the flash has been initiated in the middle of a readout of the frame). The device may not meter on the first frame and may assume subsequent frames (e.g., the following frames) have a same contribution. The device may utilize auxiliary readouts from a same (e.g., single) sensor (e.g., a same sensor may produce incremental fast readout at low resolution, without resetting), and a final long exposure may be generated by composing all images (e.g., frames).

In some examples, a device may first perform metering techniques with flash off, and may then begin main exposure and initiate a flash. The device may perform a first auxiliary readout, a second auxiliary readout, etc. (e.g., according to some number of configured auxiliary readouts by the device for flash metering). The device may then perform flash metering using the auxiliary readouts (e.g., two auxiliary readouts) to compensate for the rolling shutter issue. The device may use a flash metering result with a no-flash metering result to determine settings (e.g., to determine final flash time and integration time). In some cases, the device may set a timer for additional desired flash time. The device may then turn the flash off, and may continue main exposure according to the camera configuration. The device may then end main exposure and readout (e.g., to generate an image based on composed frames).

FIG. 5B illustrates an example of an image capture timeline 501 that supports improved flash metering for dual camera devices in accordance with aspects of the present disclosure. In some examples, image capture timeline 501 may illustrate aspects of techniques performed by a device (e.g., such as a device 110 as described with reference to FIG. 1B). Specifically, image capture timeline 501 may illustrate multi-frame flash metering techniques based on one or more captured auxiliary camera frames. In some cases, aspects of image capture timeline 501 may be implemented by a single camera (e.g., auxiliary readouts may be employed by a camera performing main image capture). As such, in some cases, techniques described in the example of FIG. 5B may be performed by a single camera device, by a single camera of a dual camera device, etc.

In example image capture timeline 501, a main sensor may be configured with two short exposures and one long exposure. Example image capture timeline 501 may illustrate implementation of rolling shutter compensation. For example, due to rolling shutter (e.g., and a flash starting in the middle of a readout), an initial readout may show more flash contribution in bottom lines (e.g., in bottom lines of the readout, after the flash has started). As such, a device may not perform metering techniques using a first frame (e.g., a frame where the flash has been initiated in the middle of a readout of the frame). The device may not meter on the first frame and may assume subsequent frames (e.g., the following frames) have a same contribution. The device may utilize auxiliary readouts from a same (e.g., single) sensor (e.g., a same sensor may produce incremental fast readout at low resolution, without resetting), and a final long exposure may be generated by composing all images (e.g., frames).

The final long exposure may be generated by composing all images. In some cases, this frame may also be used for image processing. For example, a device may analyze a second frame versus the combined frame and may apply different tone mapping and color compensation to background and foreground to produce a more natural looking image. Further, a device may utilize aspects of techniques described with reference to FIG. 3. For example, a device may capture an AUX image (e.g., employ an auxiliary readout) and meter the AUX image to determine whether additional flash is desired (e.g., and the device may configure a flash end time in the additional flash interval accordingly).

FIG. 5C illustrates an example of an image capture timeline 502 that supports improved flash metering for dual camera devices in accordance with aspects of the present disclosure. In some examples, image capture timeline 502 may illustrate aspects of techniques performed by a device (e.g., such as a device 110 as described with reference to FIG. 1B). Specifically, image capture timeline 502 may illustrate multi-frame flash metering techniques based on one or more captured auxiliary camera frames. In some cases, aspects of image capture timeline 502 may be implemented by a single camera (e.g., auxiliary readouts may be employed by a camera performing main image capture). As such, in some cases, techniques described in the example of FIG. 5C may be performed by a single camera device, by a single camera of a dual camera device, etc.

Example image capture timeline 502 may illustrate aspects of multi-frame processing techniques described herein (e.g., in low light photography). A device may correct for camera shake by registering and aligning images. The device may use the multiple frames to apply different digital processing to foreground background (e.g., the device may apply different color compensation to avoid un-natural color cast by the flash). Frames marked by “X” may be associated with a rolling shutter exposure issue. Such may be compensated for when registering the frames, or the device may drop such frames with rolling shutter exposure issue completely (e.g., the device may drop frames marked by “X” from frame registration or metering).

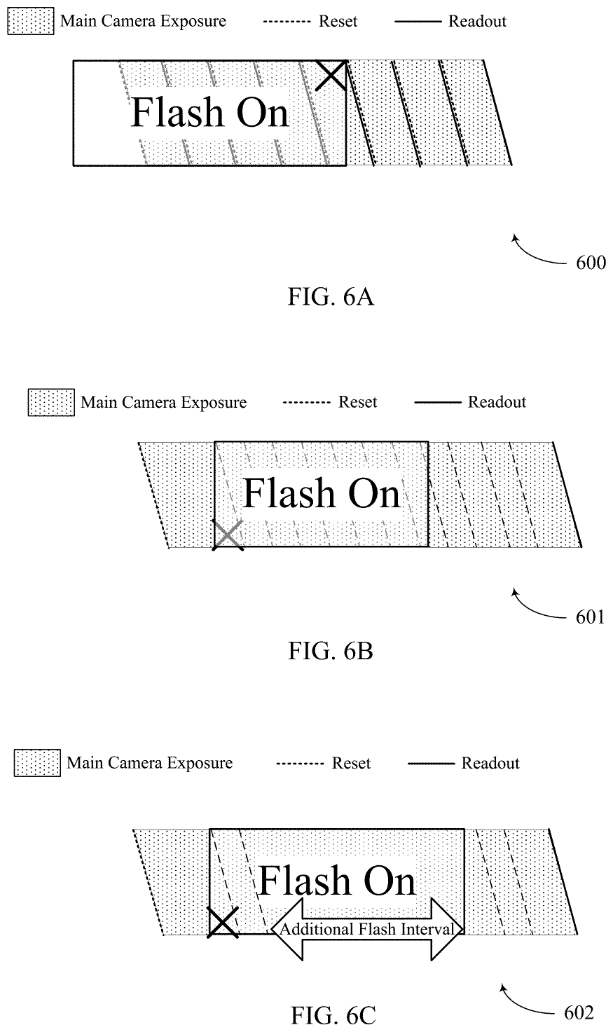

FIG. 6A illustrates an example of an image capture timeline 600 that supports improved flash metering for dual camera devices in accordance with aspects of the present disclosure. In some examples, image capture timeline 600 may illustrate aspects of techniques performed by a device (e.g., such as a device 110 as described with reference to FIG. 1B). Specifically, image capture timeline 600 may illustrate multi-frame flash metering techniques based on one or more captured auxiliary camera frames. In some cases, aspects of image capture timeline 600 may be implemented by a single camera (e.g., auxiliary readouts may be employed by a camera performing main image capture). As such, in some cases, techniques described in the example of FIG. 6A may be performed by a single camera device, by a single camera of a dual camera device, etc.

Example image capture timeline 600 may illustrate a multi-frame processing alternative. For example, a device may start flash before the first frame reset of a multi-frame capture. The device may decide on flash duration (e.g., a device may configure flash settings) based on the first frame. For example, initiating the flash before the first frame reset may facilitate the device considering the first frame without the first frame being associated with a rolling shutter exposure issue. In cases of slow sync implementations, a device may turn off flash before a readout has finished. In such cases, a device may mark a partially flashed frame (e.g., a device may mark or note a frame marked by “X” as “bad”), and the device may avoid blending the partially flashed frame in multi-frame processing.

FIG. 6B illustrates an example of an image capture timeline 601 that supports improved flash metering for dual camera devices in accordance with aspects of the present disclosure. In some examples, image capture timeline 601 may illustrate aspects of techniques performed by a device (e.g., such as a device 110 as described with reference to FIG. 1B). Specifically, image capture timeline 601 may illustrate techniques for auxiliary readouts from a main sensor (e.g., auxiliary readouts from a main camera via multiple readouts and a single reset). In some cases, aspects of image capture timeline 601 may be implemented by a single camera (e.g., auxiliary readouts may be employed by a camera performing main image capture). As such, in some cases, techniques described in the example of FIG. 6B may be performed by a single camera device, by a single camera of a dual camera device, etc.

For example, image capture timeline 601 may illustrate an example configuration of sensor readout logic that supports incremental fast readouts (e.g., auxiliary readouts) without resetting the diode. In some cases, the readout itself may result in increased noise or leakage. As such, a device may compensate by either matching the intermediate readout speed or by making intermediate readouts from interleaved lines (e.g., odd lines on one intermediate readout and even lines on next intermediate readout). The device may utilize auxiliary readouts from a same (e.g., single) sensor (e.g., a same sensor may produce incremental fast readout at low resolution, without resetting). For rolling shutter compensation, as AUX readout MAIN reset was slow and AUX readout is fast (e.g., and due to rolling shutter), initial AUX readout may show more flash contribution in bottom lines (e.g., in bottom lines of the readout, after the flash has started) and longer exposure on top lines (e.g., in top lines of the readout, before the flash has started). As such, this first AUX image (e.g., marked by “X”) may be kept in memory and subtracted from all following AUX readouts for accurate metering.

FIG. 6C illustrates an example of an image capture timeline 602 that supports improved flash metering for dual camera devices in accordance with aspects of the present disclosure. In some examples, image capture timeline 602 may illustrate aspects of techniques performed by a device (e.g., such as a device 110 as described with reference to FIG. 1B). Specifically, image capture timeline 602 may illustrate techniques for auxiliary readouts from a main sensor (e.g., auxiliary readouts from a main camera via two AUX readouts). In some cases, aspects of image capture timeline 602 may be implemented by a single camera (e.g., auxiliary readouts may be employed by a camera performing main image capture). As such, in some cases, techniques described in the example of FIG. 6C may be performed by a single camera device, by a single camera of a dual camera device, etc.

For example, image capture timeline 602 may illustrate device utilization of auxiliary readouts from a same (e.g., single) sensor (e.g., a same sensor may produce incremental fast readout at low resolution, without resetting). For rolling shutter compensation, as AUX readout MAIN reset was slow and AUX readout is fast (e.g., and due to rolling shutter), initial AUX readout may show more flash contribution in bottom lines (e.g., in bottom lines of the readout) and longer exposure on top lines (e.g., in top lines of the readout). As such, this first AUX image (e.g., marked by “X”) may be kept in memory and subtracted from all following AUX readouts for accurate metering. The second AUX readout from the first AUX readout may compensate for the rolling shutter issue. In other words, it is a simulated reset, as the result may include the light accumulated between the two readouts.

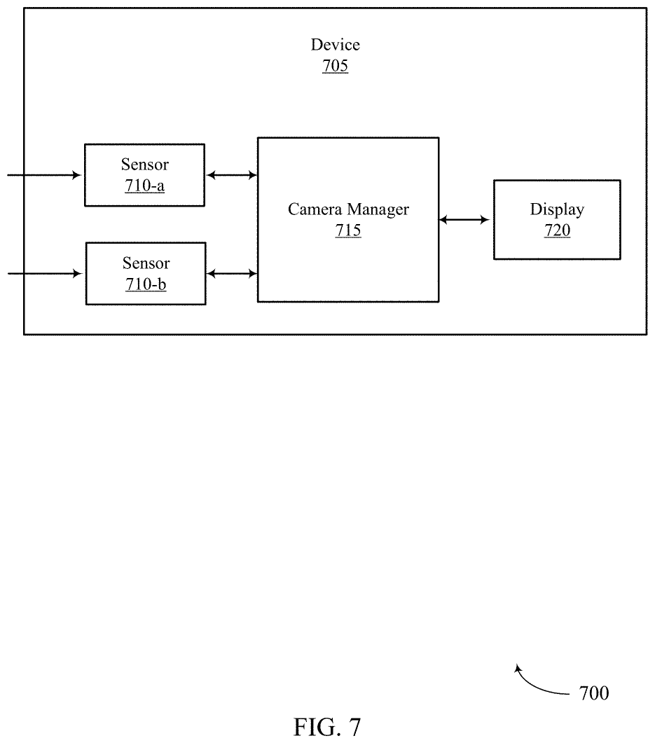

FIG. 7 shows a block diagram 700 of a device 705 that supports improved flash metering for dual camera devices in accordance with aspects of the present disclosure. The device 705 may be an example of aspects of a device as described herein. The device 705 may include one or more sensors 710, a camera manager 715, and a display 720. The device 705 may also include a processor. Each of these components may be in communication with one another (e.g., via one or more buses).

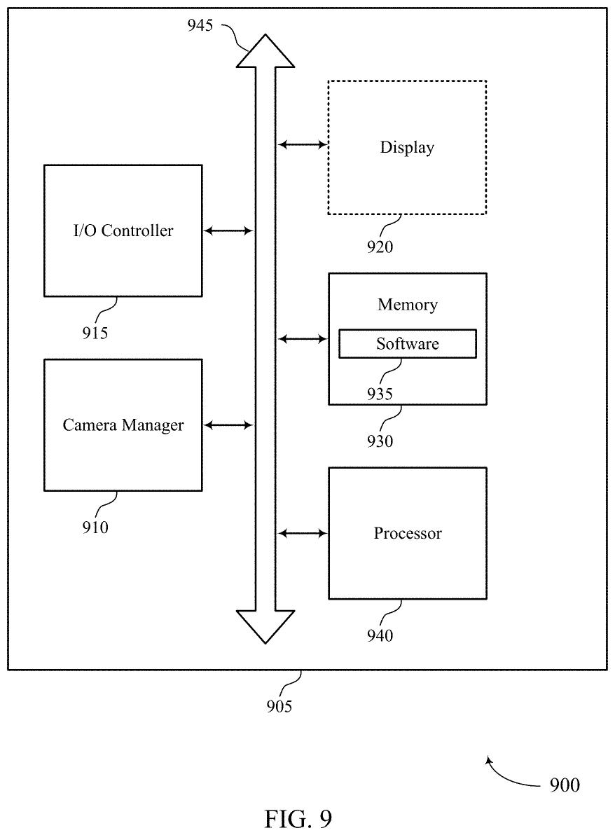

The one or more sensors 710 (e.g., image sensors, cameras) may receive information (e.g., light), which may be passed on to other components of the device 705. In some cases, the sensors 710 may be an example of aspects of the I/O controller 915 described with reference to FIG. 9. As discussed above, a sensor 710 may utilize one or more photosensitive elements that have a sensitivity to a spectrum of electromagnetic radiation to receive information (e.g., to receive a pixel intensity value, RGB values of a pixel). The information may then be passed on to other components of the device 705.

The camera manager 715 may configure an auxiliary camera (e.g., sensor 710-b) with a first frame rate and a main camera (e.g., sensor 710-a) with a second frame rate, and initiate capturing an image using the main camera. The camera manager 715 may end capturing the image by the main camera after deactivating the flash (e.g., after some duration after the flash end time). The camera manager 715 may perform, using the auxiliary camera and while capturing the image using the main camera, light metering during a duration of a flash used by the main camera, and determine, during the duration and while capturing the image using the main camera, a flash end time based on the light metering. The camera manager 715 may deactivate, while capturing the image using the main camera, the flash used by the main camera based on the flash end time. The camera manager 715 may be an example of aspects of the camera manager 710 described herein.

The camera manager 715, or its sub-components, may be implemented in hardware, code (e.g., software or firmware) executed by a processor, or any combination thereof. If implemented in code executed by a processor, the functions of the camera manager 715, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The camera manager 715, or its sub-components, may be physically located at various positions, including being distributed such that portions of functions are implemented at different physical locations by one or more physical components. In some examples, the camera manager 715, or its sub-components, may be a separate and distinct component in accordance with various aspects of the present disclosure. In some examples, the camera manager 715, or its sub-components, may be combined with one or more other hardware components, including but not limited to an I/O component, a transceiver, a network server, another computing device, one or more other components described in the present disclosure, or a combination thereof in accordance with various aspects of the present disclosure.

The display 720 may be any suitable display or screen allowing for user interaction and/or allowing for presentation of information (such as captured images and video) for viewing by a user. In some aspects, the display 720 may be a touch-sensitive display. In some cases, the display 720 may display images captured by sensor 710-a and sensor 710-b, where the displayed images that are captured by either sensor 710-a and sensor 710-b may depend on the configuration of sensor 710-a and sensor 710-b by the camera manager 715.

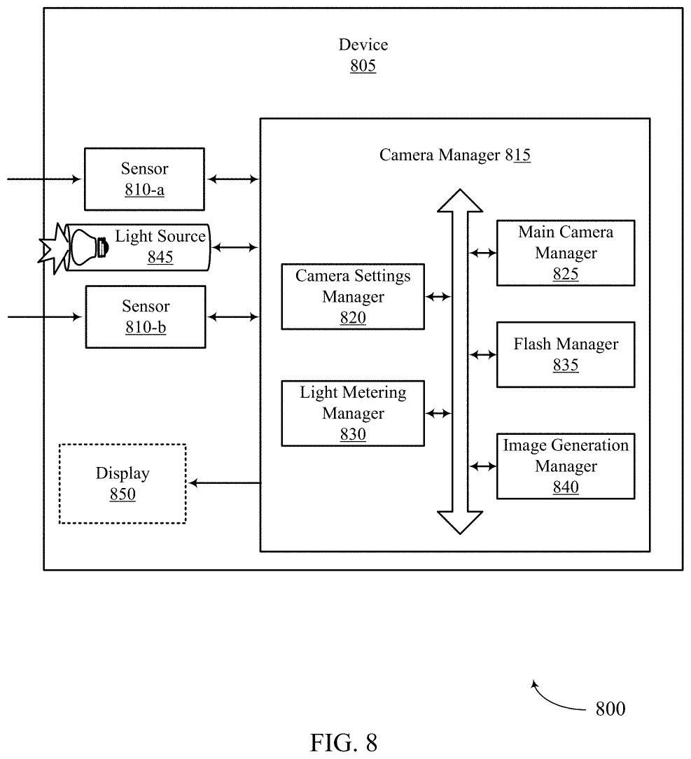

FIG. 8 shows a block diagram 800 of a device 805 that supports improved flash metering for dual camera devices in accordance with aspects of the present disclosure. The device 805 may be an example of aspects of a device 705 or a device as described herein. The device 805 may include one or more sensors 810, a camera manager 815, a light source 845, and a display 850. The camera manager 815 may be an example of aspects of a camera manager 715 or a camera manager 910 described herein. The camera manager 815 may include a camera settings manager 820, a main camera manager 825, a light metering manager 830, a flash manager 835, and an image generation manager 840. The device 805 may also include a processor. Each of these components may be in communication with one another (e.g., via one or more buses).

The one or more sensors 810 (e.g., image sensors, cameras) may receive information (e.g., light), which may be passed on to other components of the device 805. In some cases, the sensors 810 may be an example of aspects of the I/O controller 915 described with reference to FIG. 9. As discussed above, the sensors 810 may utilize one or more photosensitive elements that have a sensitivity to a spectrum of electromagnetic radiation to receive information (e.g., to receive a pixel intensity value, RGB values of a pixel). The information may then be passed on to other components of the device 805.

The camera settings manager 820 may configure an auxiliary camera (e.g., sensor 810-b) with a first frame rate and a main camera (e.g., sensor 810-a) with a second frame rate. In some examples, the camera settings manager 820 may configure the auxiliary camera with a first exposure time and the main camera with a second exposure time longer than the first exposure time, where the ending of the capturing of the image occurs after an end of the second exposure time. In some examples, the camera settings manager 820 may configure the auxiliary camera with the first frame rate and the main camera with the second frame rate that is lower than the first frame rate.

In some examples, the camera settings manager 820 may determine, during the duration and while capturing the image using the main camera, an exposure end time based on the light metering, where the ending of the capturing of the image by the main camera is based on the exposure end time. In some examples, the camera settings manager 820 may adjust the duration of the flash used by the main camera, an exposure time of the main camera, the second frame rate of the main camera, or some combination thereof, based on the light metering. In some examples, the camera settings manager 820 may determine, by the camera controller, the adjustment based on the light metering information. In some examples, the camera settings manager 820 may pass, from the camera controller to the main camera, an indication of the adjustment, where the duration of the flash used by the main camera, the exposure time of the main camera, the second frame rate of the main camera, or some combination thereof, is adjusted by the main camera based on the indication of the adjustment.

The main camera manager 825 may initiate capturing an image using the main camera. In some examples, the main camera manager 825 may end capturing the image by the main camera after deactivating the flash.

The light metering manager 830 may perform, using the auxiliary camera and while capturing the image using the main camera, light metering during a duration of a flash used by the main camera. In some examples, the light metering manager 830 may pass, from the auxiliary camera to a camera controller, light metering information based on the light metering. In some examples, the light metering manager 830 may capture one or more frames during the duration based on the first frame rate.

The flash manager 835 may determine, during the duration and while capturing the image using the main camera, a flash end time based on the light metering. In some examples, the flash manager 835 may deactivate, while capturing the image using the main camera, the flash used by the main camera based on the flash end time. In some examples, the flash manager 835 may adjust the duration of the flash used by the main camera, the exposure time of the main camera, the second frame rate of the main camera, or some combination thereof occurs while capturing the image using the main camera. In some examples, the flash manager 835 may determine, based on the light metering, that an exposure level of a portion of at least one of the one or more captured frames exceeds a threshold, where the flash end time is determined based on the determination that the exposure level exceeds the threshold.

The image generation manager 840 may generate the image based on the capturing by the main camera, where a foreground of the image is generated based on the capturing during the duration and a background of the image is generated based on the capturing after the flash end time.

The display 850 may be any suitable display or screen allowing for user interaction and/or allowing for presentation of information (such as captured images and video) for viewing by a user. In some aspects, the display 850 may be a touch-sensitive display. In some cases, the display 850 may display images captured by sensor 810-a and sensor 810-b, where the displayed images that are captured by either sensor 810-a and sensor 810-b may depend on the configuration of sensor 810-a and sensor 810-b by the camera manager 815.

FIG. 9 shows a diagram of a system 900 including a device 905 that supports improved flash metering for dual camera devices in accordance with aspects of the present disclosure. The device 905 may be an example of or include the components of device 705, device 805, or a device as described herein. The device 905 may include components for improved flash metering and improved image capture, including a camera manager 910, an I/O controller 915, a display 920, memory 930, and a processor 940. These components may be in electronic communication via one or more buses (e.g., bus 945).

The camera manager 910 may configure an auxiliary camera with a first frame rate and a main camera with a second frame rate, initiate capturing an image using the main camera, end capturing the image by the main camera after deactivating the flash, perform, using the auxiliary camera and while capturing the image using the main camera, light metering during a duration of a flash used by the main camera, determine, during the duration and while capturing the image using the main camera, a flash end time based on the light metering, and deactivate, while capturing the image using the main camera, the flash used by the main camera based on the flash end time.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The memory 930 may include RAM and ROM. The memory 930 may store computer-readable, computer-executable code or software 935 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting improved flash metering for dual camera devices).

The software 935 may include instructions to implement aspects of the present disclosure, including instructions to support image processing. The software 935 may be stored in a non-transitory computer-readable medium such as system memory or other type of memory. In some cases, the software 935 may not be directly executable by the processor 940 but may cause a computer (e.g., when compiled and executed) to perform functions described herein.

The display 920 may be any suitable display or screen allowing for user interaction and/or allowing for presentation of information (such as captured images and video) for viewing by a user. In some aspects, the display 920 may be a touch-sensitive display. In some cases, the display 920 may display images captured by sensors, where the displayed images that are captured by sensors may depend on the configuration of active sensors by the camera manager 910. In some cases, display 920 may be, or refer to, a same component as I/O controller 915, or display 920 and I/O controller 915 may be separate components.

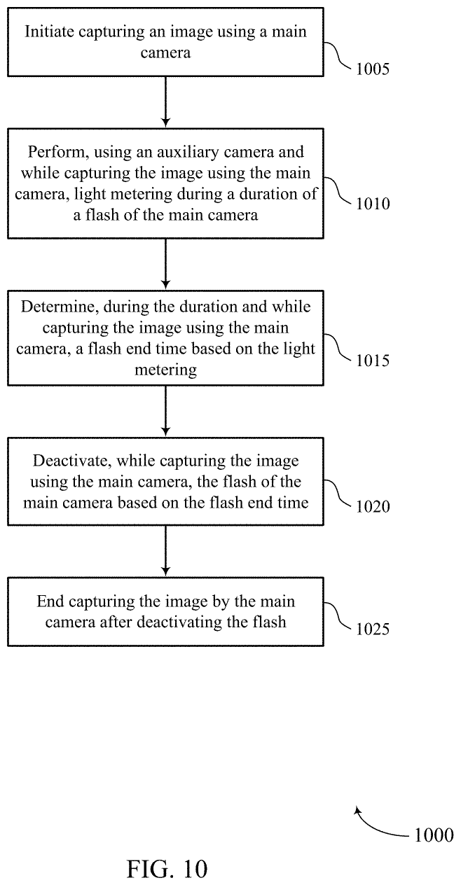

FIG. 10 shows a flowchart illustrating a method 1000 that supports improved flash metering for dual camera devices in accordance with aspects of the present disclosure. The operations of method 1000 may be implemented by a device or its components as described herein. For example, the operations of method 1000 may be performed by a camera manager as described with reference to FIGS. 7 through 9. In some examples, a device may execute a set of instructions to control the functional elements of the device to perform the functions described below. Additionally or alternatively, a device may perform aspects of the functions described below using special-purpose hardware.

At 1005, the device may initiate capturing an image using a main camera. The operations of 1005 may be performed according to the methods described herein. In some examples, aspects of the operations of 1005 may be performed by a main camera manager as described with reference to FIGS. 7 through 9.

At 1010, the device may perform, using an auxiliary camera and while capturing the image using the main camera, light metering during a duration of a flash used by the main camera. The operations of 1010 may be performed according to the methods described herein. In some examples, aspects of the operations of 1010 may be performed by a light metering manager as described with reference to FIGS. 7 through 9.

At 1015, the device may determine, during the duration and while capturing the image using the main camera, a flash end time based on the light metering. The operations of 1015 may be performed according to the methods described herein. In some examples, aspects of the operations of 1015 may be performed by a flash manager as described with reference to FIGS. 7 through 9.

At 1020, the device may deactivate, while capturing the image using the main camera, the flash used by the main camera based on the flash end time. The operations of 1020 may be performed according to the methods described herein. In some examples, aspects of the operations of 1020 may be performed by a flash manager as described with reference to FIGS. 7 through 9.

At 1025, the device may end capturing the image by the main camera after deactivating the flash. The operations of 1025 may be performed according to the methods described herein. In some examples, aspects of the operations of 1025 may be performed by a main camera manager as described with reference to FIGS. 7 through 9.

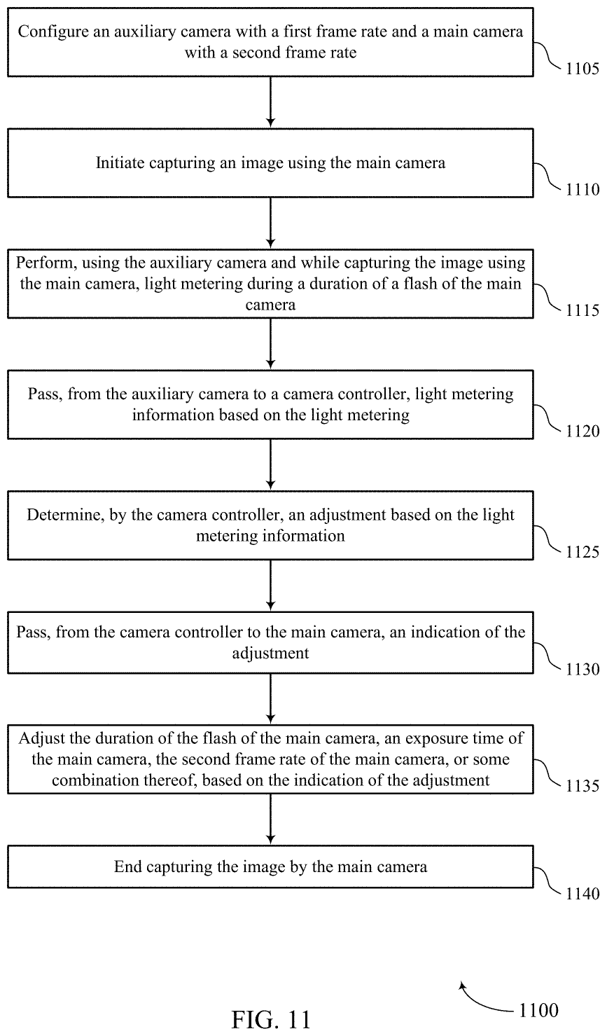

FIG. 11 shows a flowchart illustrating a method 1100 that supports improved flash metering for dual camera devices in accordance with aspects of the present disclosure. The operations of method 1100 may be implemented by a device or its components as described herein. For example, the operations of method 1100 may be performed by a camera manager as described with reference to FIGS. 7 through 9. In some examples, a device may execute a set of instructions to control the functional elements of the device to perform the functions described below. Additionally or alternatively, a device may perform aspects of the functions described below using special-purpose hardware.

At 1105, the device may configure an auxiliary camera with a first frame rate and a main camera with a second frame rate. The operations of 1105 may be performed according to the methods described herein. In some examples, aspects of the operations of 1105 may be performed by a camera settings manager as described with reference to FIGS. 7 through 9.

At 1110, the device may initiate capturing an image using the main camera. The operations of 1110 may be performed according to the methods described herein. In some examples, aspects of the operations of 1110 may be performed by a main camera manager as described with reference to FIGS. 7 through 9.

At 1115, the device may perform, using the auxiliary camera and while capturing the image using the main camera, light metering during a duration of a flash used by the main camera. The operations of 1115 may be performed according to the methods described herein. In some examples, aspects of the operations of 1115 may be performed by a light metering manager as described with reference to FIGS. 7 through 9.

At 1120, the device may pass, from the auxiliary camera to a camera controller, light metering information based on the light metering. The operations of 1120 may be performed according to the methods described herein. In some examples, aspects of the operations of 1120 may be performed by an auxiliary camera (e.g., sensor) and/or a light metering manager as described with reference to FIGS. 7 through 9.

At 1125, the device may determine, by the camera controller, an adjustment based on the light metering information. For example, the device may determine an adjustment to the duration of the flash used by the main camera, an adjustment to the exposure time of the main camera, an adjustment to the second frame rate of the main camera, etc. The operations of 1125 may be performed according to the methods described herein. In some examples, aspects of the operations of 1125 may be performed by a camera settings manager (e.g., a camera controller) as described with reference to FIGS. 7 through 9.

At 1130, the device may pass, from the camera controller to the main camera, an indication of the adjustment, where the duration of the flash used by the main camera, the exposure time of the main camera, the second frame rate of the main camera, or some combination thereof, is adjusted by the main camera based on the indication of the adjustment. The operations of 1130 may be performed according to the methods described herein. In some examples, aspects of the operations of 1130 may be performed by a camera settings manager and/or a main camera (e.g., a sensor) as described with reference to FIGS. 7 through 9.

At 1135, the device may adjust the duration of the flash used by the main camera, an exposure time of the main camera, the second frame rate of the main camera, or some combination thereof, based on the indication of the adjustment. The operations of 1135 may be performed according to the methods described herein. In some examples, aspects of the operations of 1135 may be performed by a camera settings manager as described with reference to FIGS. 7 through 9.

At 1140, the device may end capturing the image by the main camera (e.g., based at least in part on the adjustment). The operations of 1140 may be performed according to the methods described herein. In some examples, aspects of the operations of 1140 may be performed by a main camera manager and/or a main camera (e.g., sensor) as described with reference to FIGS. 7 through 9.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
configuring an auxiliary camera with a first frame rate and a main camera with a second frame rate;
initiating capturing an image using the main camera;
performing, using the auxiliary camera and while capturing the image using the main camera, light metering during a duration of a flash used by the main camera;
determining, during the duration and while capturing the image using the main camera, a flash end time based at least in part on the light metering;
deactivating, while capturing the image using the main camera, the flash used by the main camera based at least in part on the flash end time; and
ending capturing the image by the main camera after deactivating the flash.

2. The method of claim 1, further comprising:
configuring the auxiliary camera with a first exposure time and the main camera with a second exposure time longer than the first exposure time, wherein the ending of the capturing of the image occurs after an end of the second exposure time.

3. The method of claim 2, further comprising:
generating the image based at least in part on the capturing by the main camera, wherein a foreground of the image is generated based at least in part on the capturing during the duration and a background of the image is generated based at least in part on the capturing after the flash end time.

4. The method of claim 1, wherein the configuring comprises:
configuring the auxiliary camera with the first frame rate and the main camera with the second frame rate that is lower than the first frame rate.

5. The method of claim 1, further comprising:
determining, during the duration and while capturing the image using the main camera, an exposure end time based at least in part on the light metering, wherein the ending of the capturing of the image by the main camera is based at least in part on the exposure end time.

6. The method of claim 1, further comprising:
adjusting the duration of the flash used by the main camera, an exposure time of the main camera, the second frame rate of the main camera, or some combination thereof, based at least in part on the light metering.

7. The method of claim 6, further comprising:
passing, from the auxiliary camera to a camera controller, light metering information based at least in part on the light metering;
determining, by the camera controller, the adjustment based at least in part on the light metering information; and
passing, from the camera controller to the main camera, an indication of the adjustment, wherein the duration of the flash used by the main camera, the exposure time of the main camera, the second frame rate of the main camera, or some combination thereof, is adjusted by the main camera based at least in part on the indication of the adjustment.

8. The method of claim 7, wherein:
adjusting the duration of the flash used by the main camera, the exposure time of the main camera, the second frame rate of the main camera, or some combination thereof occurs while capturing the image using the main camera.

9. The method of claim 1, wherein performing the light metering comprises:
capturing one or more frames during the duration based at least in part on the first frame rate.

10. The method of claim 9, wherein determining the flash end time further comprises:
determining, based at least in part on the light metering, that an exposure level of a portion of at least one of the one or more captured frames exceeds a threshold, wherein the flash end time is determined based at least in part on the determination that the exposure level exceeds the threshold.

11. An apparatus for image processing at a device, comprising:
a processor,
memory coupled with the processor; and
instructions stored in the memory and executable by the processor to cause the apparatus to:
configure an auxiliary camera with a first frame rate and a main camera with a second frame rate;
initiate capturing an image using the main camera;
perform, using the auxiliary camera and while capturing the image using the main camera, light metering during a duration of a flash used by the main camera;
determine, during the duration and while capturing the image using the main camera, a flash end time based at least in part on the light metering;
deactivate, while capturing the image using the main camera, the flash used by the main camera based at least in part on the flash end time; and
end capturing the image by the main camera after deactivating the flash.

12. The apparatus of claim 11, wherein the instructions are further executable by the processor to cause the apparatus to:
configure the auxiliary camera with a first exposure time and the main camera with a second exposure time longer than the first exposure time, wherein the ending of the capturing of the image occurs after an end of the second exposure time.

13. The apparatus of claim 12, wherein the instructions are further executable by the processor to cause the apparatus to:
generate the image based at least in part on the capturing by the main camera, wherein a foreground of the image is generated based at least in part on the capturing during the duration and a background of the image is generated based at least in part on the capturing after the flash end time.

14. The apparatus of claim 11, wherein the configuring comprises:
configure the auxiliary camera with the first frame rate and the main camera with the second frame rate that is lower than the first frame rate.

15. The apparatus of claim 11, wherein the instructions are further executable by the processor to cause the apparatus to:
determine, during the duration and while capturing the image using the main camera, an exposure end time based at least in part on the light metering, wherein the ending of the capturing of the image by the main camera is based at least in part on the exposure end time.

16. The apparatus of claim 11, wherein the instructions are further executable by the processor to cause the apparatus to:
adjust the duration of the flash used by the main camera, an exposure time of the main camera, the second frame rate of the main camera, or some combination thereof, based at least in part on the light metering.

17. The apparatus of claim 16, wherein the instructions are further executable by the processor to cause the apparatus to:
pass, from the auxiliary camera to a camera controller, light metering information based at least in part on the light metering;
determine, by the camera controller, the adjustment based at least in part on the light metering information; and
pass, from the camera controller to the main camera, an indication of the adjustment, wherein the duration of the flash used by the main camera, the exposure time of the main camera, the second frame rate of the main camera, or some combination thereof, is adjusted by the main camera based at least in part on the indication of the adjustment.

18. The apparatus of claim 17, wherein adjusting the duration of the flash used by the main camera, the exposure time of the main camera, the second frame rate of the main camera, or some combination thereof occurs while capturing the image using the main camera.

19. The apparatus of claim 11, wherein the instructions to perform the light metering are executable by the processor to cause the apparatus to:
capture one or more frames during the duration based at least in part on the first frame rate.

20. A non-transitory computer-readable medium storing code for image processing at a device, the code comprising instructions executable by a processor to:
configure an auxiliary camera with a first frame rate and a main camera with a second frame rate;
initiate capturing an image using the main camera;
perform, using the auxiliary camera and while capturing the image using the main camera, light metering during a duration of a flash used by the main camera;
determine, during the duration and while capturing the image using the main camera, a flash end time based at least in part on the light metering;
deactivate, while capturing the image using the main camera, the flash used by the main camera based at least in part on the flash end time; and
end capturing the image by the main camera after deactivating the flash.
